(19) United States
(12) Patent Application Publication
(10) Pub. No.: US 2011/0179049 A1
(43) Pub. Date: Jul. 21, 2011

(54) Automatic Aggregation Across Data Stores and Content Types

(75) Inventors: Nicholas Caldwell, Bellevue, WA (US); Venkat Pradeep Chilakamarri, Redmond, WA (US); Saliha Azzam, Redmond, WA (US); Yizheng Cai, Sammamish, WA (US); Michael Calcagno, Kirkland, WA (US); Benjamin Edward Childs, Seattle, WA (US); Arun Chitrapu, Seattle, WA (US); Steven Dimmick, Mill Creek, WA (US); Michael Gamon, Seattle, WA (US); Bernhard SJ Kohlmeier, Woodinville, WA (US); Shiun-Zu Kuo, Bothell, WA (US); Jonathan C. Ludwig, Kirkland, WA (US); Kimberly Manis, Seattle, WA (US); Courtney Anne O'Keefe, Bellevue, WA (US); Diego Perez Del Carpio, Redmond, WA (US); Tu Huy Phan, Redmond, WA (US); Kevin Powell, Kirkland, WA (US); Jignesh Shah, Bellevue, WA (US); Ashish Sharma, Bellevue, WA (US); Paulus Willem ter Horst, Bothell, WA (US); Mukta Pramod Walvekar, Sammamish, WA (US); Ye-Yi Wang, Redmond, WA (US)

(73) Assignee: Microsoft Corporation, Redmond, WA (US)

(21) Appl. No.: 12/818,667

(22) Filed: Jun. 18, 2010

Related U.S. Application Data
(60) Provisional application No. 61/296,343, filed on Jan. 19, 2010.

(51) Int. Cl. G06F 17/30

(52) U.S. Cl. 707/755; 707/E17.058

(57) ABSTRACT

Project-related data may be aggregated from various data sources, given context, and may be stored in a data repository or organizational knowledge base that may be available to and accessed by others. Documents, emails, contact information, calendar data, social networking data, and any other content that is related to a project may be brought together within a single user interface, irrespective of its data type. A user may organize and understand content, discover relevant information, and act on it without regard to where the information resides or how it was created.

### CROSS REFERENCE TO RELATED APPLICATIONS

This application claims benefit under 35 U.S.C. §119(e) of U.S. Provisional Patent application Ser. No. 61/296,343 entitled “Aggregating and Presenting Associated Information (Huddle)” and filed on Jan. 19, 2010, the entirety of which is incorporated by reference herein.

### BACKGROUND

Information workers, home users, and end users may oftentimes be overwhelmed by the amount of information they must deal with. Information workers may oftentimes be forced to look at their tasks and responsibilities from an application-centric viewpoint, and may struggle to get their work done. Home and end users may oftentimes be confronted with disruptions to their lives that may require them to turn into project managers without any focused support. Currently, information workers may use various storage and information retrieval techniques, from browsing to search, sticky notes to e-mail rules, to try to organize their projects. Many organizations develop custom applications, from lightweight to heavyweight, to help manage projects. As can be appreciated, this can cause significant overhead. End users, home users, and workers of small and medium-sized businesses may be left to their own devices, and may use anything from traditional paper-based methods to social networking. All of these methods fail to address the fundamental problem of bringing all the relevant information together into one place and helping users to get on top of the information they are dealing with.

### SUMMARY

Embodiments of the present invention solve the above and other problems by providing for aggregating data, providing context to the data, and allowing a user to use the aggregated data and context as a tool with which to manage and organize a project. Embodiments may be utilized to organize and understand content, discover relevant information, and act on it without regard to where the information resides or how it was created. By utilizing various technologies, including but not limited to, natural language technologies, search and machine-learning technologies, aggregation and extraction of information may require minimal user effort. Embodiments of the present invention may be utilized by information workers in a managed space as well as by users of small and medium-sized businesses and individuals in an unmanaged space.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

FIG. 1 is a block diagram showing the architecture of a system for providing an automatic aggregation of data from multiple sources and automatic suggestion of related content.

FIG. 2 is an illustration of an example PDAM application UI 112 showing an overview pane.

FIG. 3 is an illustration of an example PDAM application UI 112 showing an email panel 300.

FIG. 4 is an illustration of an example PDAM application UI 112 showing a calendar panel 400.

FIG. 5 is an illustration of an example PDAM application UI 112 showing n task panel 500.

FIG. 6 is an illustration of an example PDAM application UI 112 showing a contacts panel 600.

FIG. 7 is an illustration of an example PDAM application UI 112 showing a documents panel 700.

FIG. 8 is an illustration of an example PDAM application UI 112 showing a notes panel 800.

FIG. 9 is an illustration of an example PDAM application UI 112 showing a QnA panel 900.

FIG. 10 is an illustration of an example PDAM application UI 112 showing a lingo panel 1000.

FIG. 11 is an illustration of an example PDAM application UI 112 showing a bug panel 1100.

FIG. 12 is an illustration of an example PDAM application UI 112 showing a dashboard panel 1200.

FIG. 13 is an illustration of an example PDAM application UI 112 showing a preview panel 1300.

FIG. 14 is an illustration of an example PDAM application UI 112 showing a notes page 1402 in a preview panel 1300.

FIG. 15 is an illustration of an example PDAM application UI 112 showing a related items page 1502 in a preview panel 1300.

FIG. 16A is an illustration of an example PDAM application UI 112 showing a summary tab 1604 in a preview panel 1300.

FIG. 16B is an illustration of an example PDAM application UI 112 showing a document preview tab 1606 in a preview panel 1300.

FIG. 16C is an illustration of an example PDAM application UI 112 showing a clip art preview tab 1608 in a preview panel 1300.

FIG. 16D is an illustration of an example PDAM application UI 112 showing a links tab 1610 in a preview panel 1300.

FIG. 16E is an illustration of an example PDAM application UI 112 showing a terminology tab 1612 in a preview panel 1300.

FIG. 17 is a flowchart illustrating a method for bringing together project-related content from various data repositories.

FIG. 18 is a block diagram of a system including a computing device 1800.

### DETAILED DESCRIPTION

The following description refers to the accompanying drawings. Whenever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Consistent with embodiments of the invention, systems, methods and computer readable media are provided for allowing a user to organize and understand content, discover relevant information, and act on the content and information without regard to where the content and/or information resides or how it was created. Consider, for example, a prototypical information worker (IW). In the IW's enterprise, his/her workday may entail juggling between three separate projects that he/she is currently working on. Each of the projects may have a dedicated team of researchers with which the IW interfaces on a daily basis. Consider that most communication within the project teams occurs via email, and the IW receives upwards of a hundred emails a day from colleagues asking him/her questions about one or more projects. Over the course of a year, the information worker may have created a wealth of documentation scattered across databases, servers, content management systems, his/her inbox, and his/her desktop.

Embodiments of the present invention may be utilized as a project data aggregation and management tool (herein referred to as a PDAM application) to help users to be more efficient in managing projects and information that is related to the projects. A project summary and alert feature may give a user an overview of his/her projects. An email management and prioritization may allow a user to set his/her work status to one of his/her projects. Once set in a project mode, embodiments of the present invention may help the user to concentrate on the task at hand by effectively prioritizing and filtering all incoming communications from his/her colleagues. A document organization and reusable content feature may allow a user to manage all of his/her documents, irrespective of content type or location. A collaboration feature may allow a user to collaborate with his/her project coworkers by sharing review comments and notes, asking and answering project-related questions, assigning tasks to others as well as reporting on progress on assigned tasks. Embodiments of the present invention go beyond being an aggregator of content to being a repository of shared workgroup-wisdom and expertise. A team reference set feature may flag and store reusable contextual information, such as frequently asked questions, acronym definitions, and glossaries into a shared and searchable store where others can find it. Embodiments of the present invention may serve as a user's window to goings-on in a broader project workgroup. Alert and notification features may help ensure that significant events and developments in a project are recorded and broadcast to a team in real time. This may help everyone in a workgroup to stay up-to-date on information that is relevant to the projects with which they are engaged.

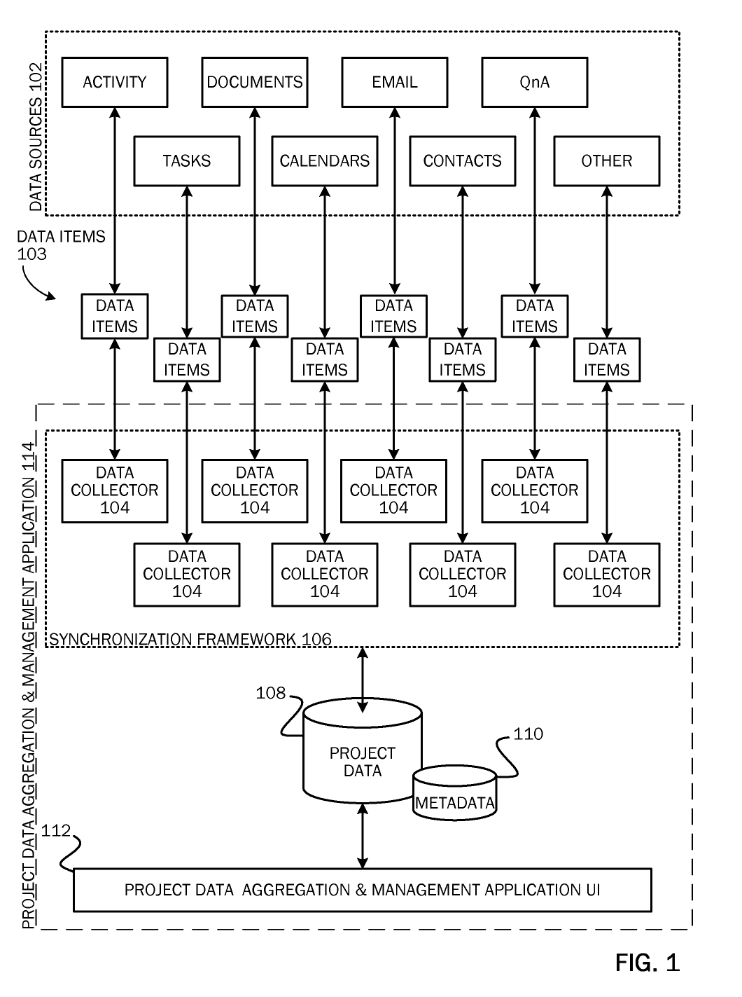

Referring now to FIG. 1, a simplified block diagram of a system architecture for embodiments of the present invention is illustrated. As was briefly described above, embodiments of the present invention may be utilized as a project data aggregation and management tool. Data items 103 may be of various content types, and may be from various data sources 102. Data sources 102 may include, but are not limited to, activities, documents, electronic mail, questions and answers, tasks, calendars, and contacts, or any other electronic data from which data relevant to a one or more projects may be retrieved. Data items 103 may be located within a local file system, within a web-based content management system, such as SHAREPOINT by MICROSOFT CORPORATION of Redmond, Wash., or located remotely and linked through a communications network. In a distributed computing environment, data items 103 may be located in both local and remote memory storage devices. A data item 103 may be, for example, a calendar item, a contact item, an electronic mail (“email”) communication, a task item, an electronic document (e.g., word processing document, spreadsheet document, slide presentation document, etc.), photographic files, audio files, or any other item of data that may be relevant to one or more projects of interest.

Embodiments of the present invention may comprise a synchronization framework 106, which is a framework of data collection interfaces 104, herein referred to as data collectors. A data collector 104 is an interface that may communicate with a data source 102, and pull data items 103 that may contain relevant information to a project from the data source 102. A project may be created by a user within a PDAM application 114. When a project is created, a title and description may be given to the project, which may be used as metadata 110 for discovering content that may be of relevance to the project. Data collectors 104 may search for content locally and from external repositories. Discovered content may be suggested to a user, wherein the user may accept a suggested piece of content and that data item 103 may be extracted and stored into a project data store 108.

Information that is exchanged between a data source 102 and a data collector 104 may be customizable. For example, if the data source 102 is an electronic mail application, electronic calendar application, electronic task application, or an application that provides combined resources of these applications, for example, OUTLOOK by MICROSOFT CORPORATION of Redmond, Wash., a data collector 104 may be implemented to interface the email application so that it may be operative for discovering data and metadata of an email. As should be appreciated, there may be multiple extraction points of a data source 102. Accordingly, there may be multiple data collectors 104 for a data source 102. Considering the above example, where the data source 102 is an electronic mail application, electronic calendar application, electronic task application, or combination functionality application, one data collector 104 may be implemented to discover email data, and another data collector 104 may be implemented to discover calendar data, and another to discover task data, etc. A data collector 104 may know not only where to get data, but also how and what type of data to retrieve.

As new data sources 102 are added to a project, a synchronization framework 106 may implement new data collector 104 interfaces. For every possible type of collection, an implementation of that interface may be added to the synchronization framework 106. The synchronization framework 106 may pull in data as well as push data back out to a data source 102. Data may be pulled in via one of two modes. According to a first mode, a data source 102 may be checked for new content according to a specified time interval. For example, a data source 102 may be checked every thirty (30) seconds to see if there is new data available. With some data sources 102, it may be inefficient to pull data in such a manner. By utilizing a subscriber-type model, a data source 102 may notify the synchronization framework 106 when a change occurs. Consider, for example, that a data collection, organization and sharing application, for example, SHAREPOINT by MICROSOFT CORPORATION is a data source 102 for a project. The application may use very large lists to transfer data. The list may have thousands of elements, so it would be inefficient to pull them and check a thousand elements every thirty (30) seconds for new data. Accordingly, a second mode may be utilized to check for new data. The synchronization framework 106 may register for an event, wherein the synchronization framework 106 may be notified when a change has occurred.

As data items 103 that are of relevance to a project are pulled from a data source 102 by a data collector, that data may be stored in a project data store 108. The project data store 108 is a data repository or organizational knowledge base, and may be available to and access by others. Data collectors 104 may put data into a project data store 108 in whatever way may be most efficient for the system. For example, if document information is being collected, that data may be put into the data store 108 by downloading the document and associating the whole document with the project. Alternatively, instead of downloading the full document, a link to the document may be downloaded; and, the link information may be tagged with a last modification date. In the same way that various forms of data may be collected from a variety of aggregation points, the way the data is stored internally can vary. Project data 108 may be a collection of identifications to actual data that may be stored locally or in disparate locations. Data may comprise project related content as well as contact information, and any other available content that may be relevant to a project. A project data store 108 may also comprise metadata 110, such as a title, description, other people who may be joined and working on a project, security descriptors, types of content that should be stored within a project, and how it should be displayed in a user interface 112.

According to one embodiment, data may be stored in a data base table, for example a structured query language (SQL) data table. After a project data store 108 is created, all associated content may be added into the data store. The content may consist of a generic wrapper that provides a name, an identifier, a creation date, and other pieces of metadata along with payloads, which consist of the actual data or links to the actual data. For example, if a user adds a contact to a project, a wrapper may be created that may contain a title of the contact, a date it was created, etc., and a payload. For a contact, the payload would be the unique identifier of the user who is being added as a contact. For every type of content within a project, a wrapper and payload exists.

According to an embodiment, a project may coexist with enterprise-level structured projects which may be projects associated with data, data sources and projects spanning organizations and entities of varying sizes and structures. An enterprise project may be a source from which information may be extracted. An enterprise project may comprise deliverables, which may be defined as PDAM application projects. An overall project system may manage these deliverables or PDAM application projects.

A PDAM application user interface (UI) 112 is a modular user interface that may display data items 103 from multiple data sources 102. For example, a PDAM application UI 112 may display data items 103 like calendar data, emails, tasks, etc. as well as any other type of data, such as word processing documents, spreadsheet documents, presentation documents, and social networking correspondences. The PDAM application UI 112 may borrow functionality of one or more applications, such as an electronic mail application, electronic calendar application, electronic task application, or an application that provides combined resources of these applications for displaying and interacting with calendar, task and email items. The PDAM application UI 112 may also extend functionalities of other applications so that it may display other relevant project information.

Within a PDAM application UI 112, a notification system may be provided. According to an embodiment, when a data collector 104 retrieves a data item 103 from a data source 102, a user may be notified through the PDAM application UI 112 that new information is available, so that the user may then act on it. For example, a person in a project may upload a new document relative to the project. Other members in the project may need to know that a new document has been uploaded. The other users may receive a notification that a new activity is available.

According to another embodiment, a user may publish new data through the PDAM application UI 112 that can be sent out to various data sources 102. For example, if a user has a project linked to various communication sources, such as email, instant messaging, and one or more social networks, for example, FACEBOOK or TWITTER, the user may push content back out to one or more of those communication sources. The user may create an email or text message or other suitable messaging form from within the PDAM application UI 112. The PDAM application UI 112 may act as an aggregator of content as well as a way to push content back out to any desired recipient user or recipient system.

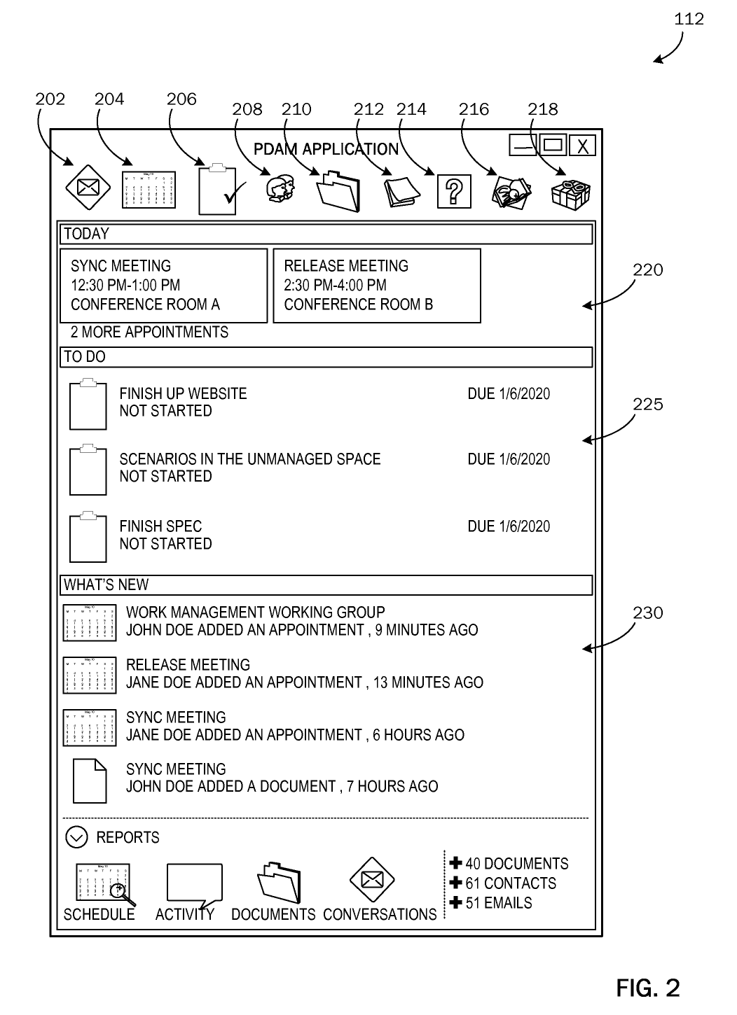

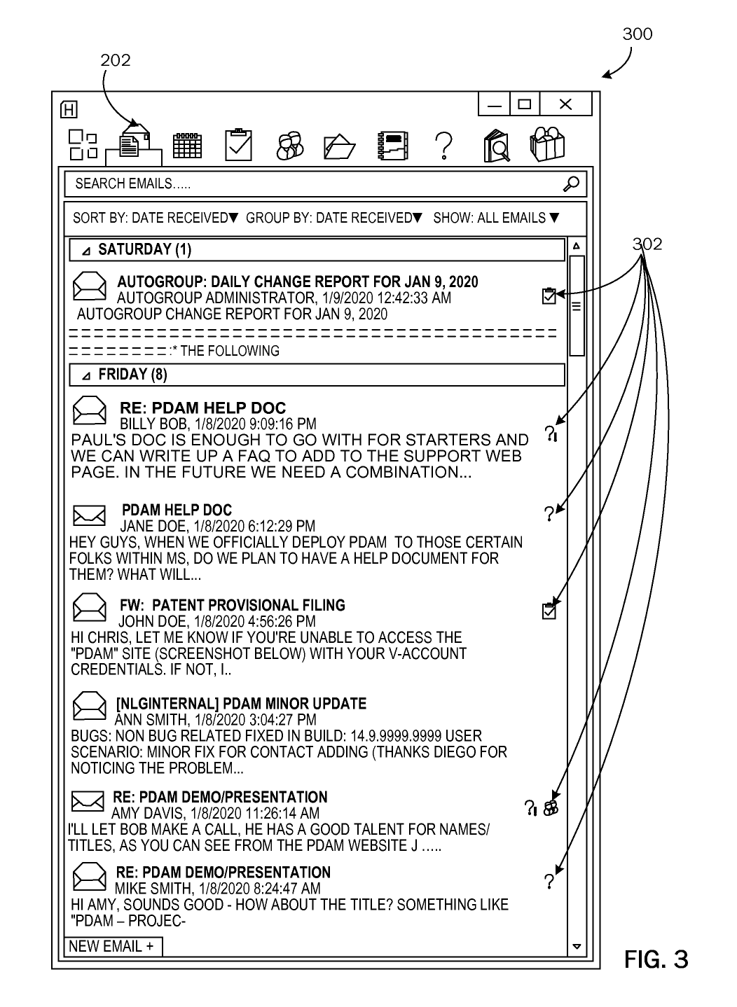

FIG. 2 is an illustration of one example of a PDAM application user interface 112, wherein an overview pane is shown, which may show a user's upcoming appointments 220, to-do items 225 as well as workgroup activity data 230 from across a series of content-stores and data sources 102. Various selectable icons 202, 204, 206, 208, 210, 212, 214, 216, 218 may be displayed within the UI 112, which when selected may open various views in the application for specific content types within a project collection as will be described below with reference to FIGS. 3-16. As should be appreciated, the following discussion of various information views associated with specific content types is for purposes of example and is not limiting of the vast numbers of content types for which one or more information views may be constructed in accordance with embodiments of the present invention.

A selection of an email icon 202 may launch an email panel 300, which may show all of the emails from a user's inbox that pertain to the current project as shown in FIG. 3. Email items that contain tasks, calendar items, contacts, or questions and answers may be flagged 302. Users can utilize these flags 302 to filter and sort their email. By clicking on a flag 302, a user may promote the extracted task, calendar item, or question and answer to being a top level citizen in a project collection.

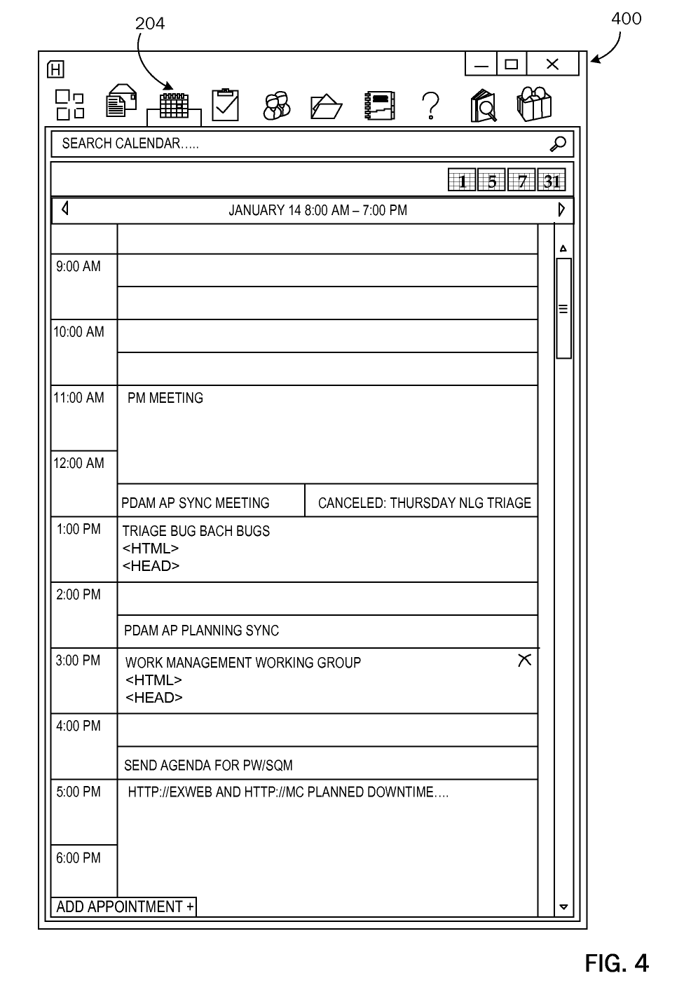

A selection of a calendar icon 204 may launch a calendar panel 400 as shown in FIG. 4. A calendar panel 400 may show all of a user's upcoming appointments relating to the current project highlighted on the calendar.

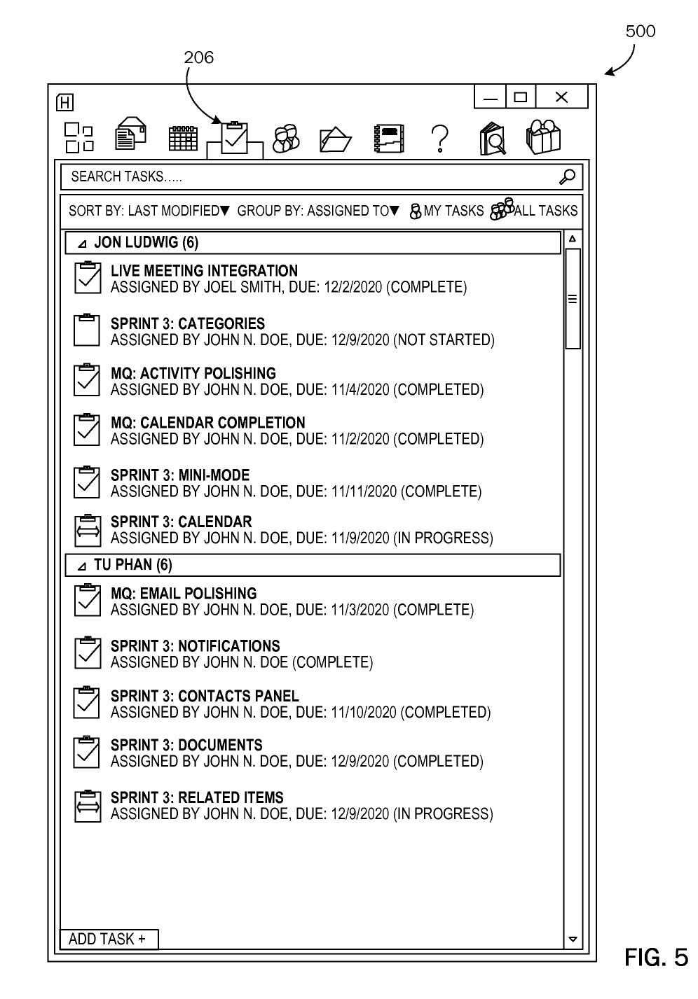

A selection of a task icon 206 may launch a task panel 500 as shown in FIG. 5. A task panel 500 may show a unified view of all the tasks and to-do lists from members of a project team as well as a status snapshot (e.g., not started, in progress, or completed). A user may utilize a task panel 500 to update his/her own task status.

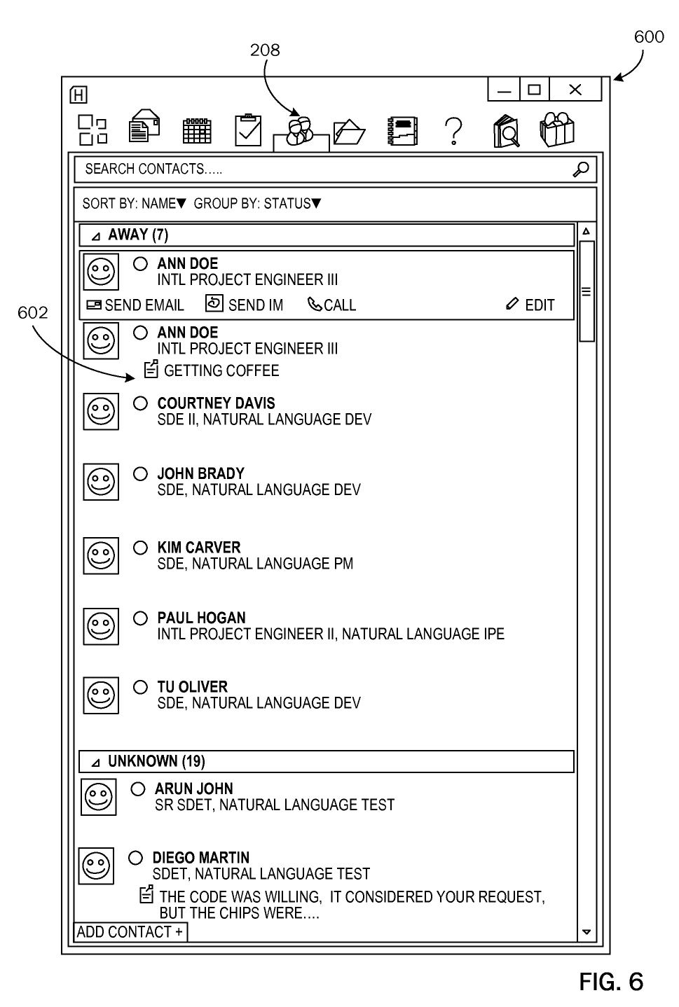

A selection of a contacts icon 208 may launch a contacts panel 600 as shown in FIG. 6. A contacts panel 600 is a repository of contact information of both workgroup members as well as others related to a project. The contacts panel 600 may show availability status 602 as well as status messages.

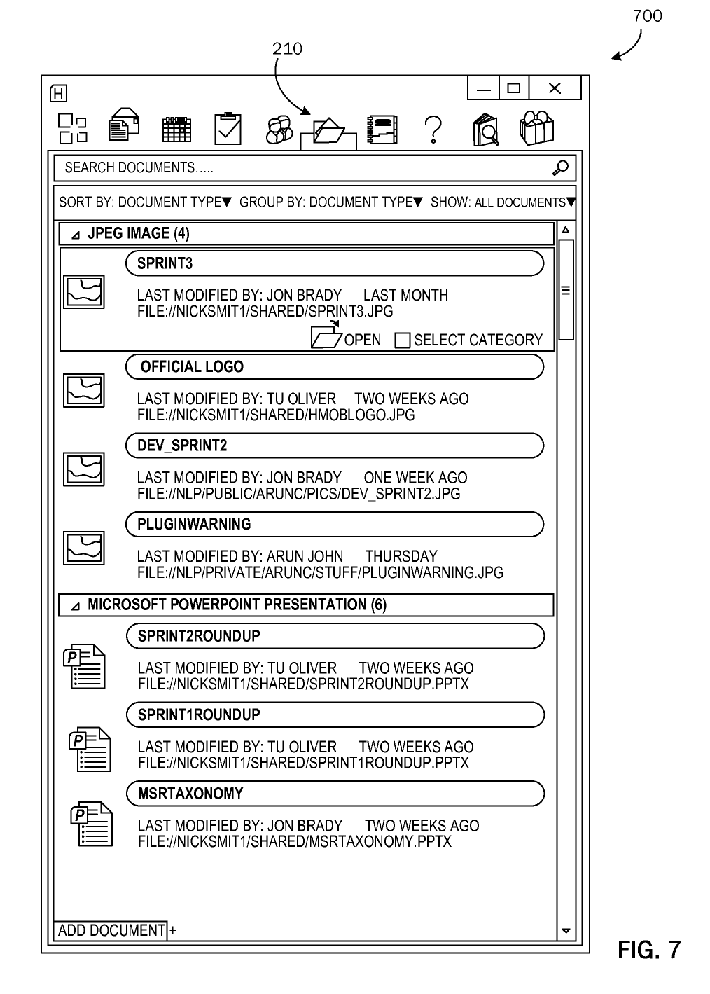

A selection of a documents icon 210 may launch a documents panel 700 as shown in FIG. 7. A documents panel 700 may show all documents related to a project from across various document repositories, including, but not limited to, a user's desktop, any remote file-share, and web-based file management systems.

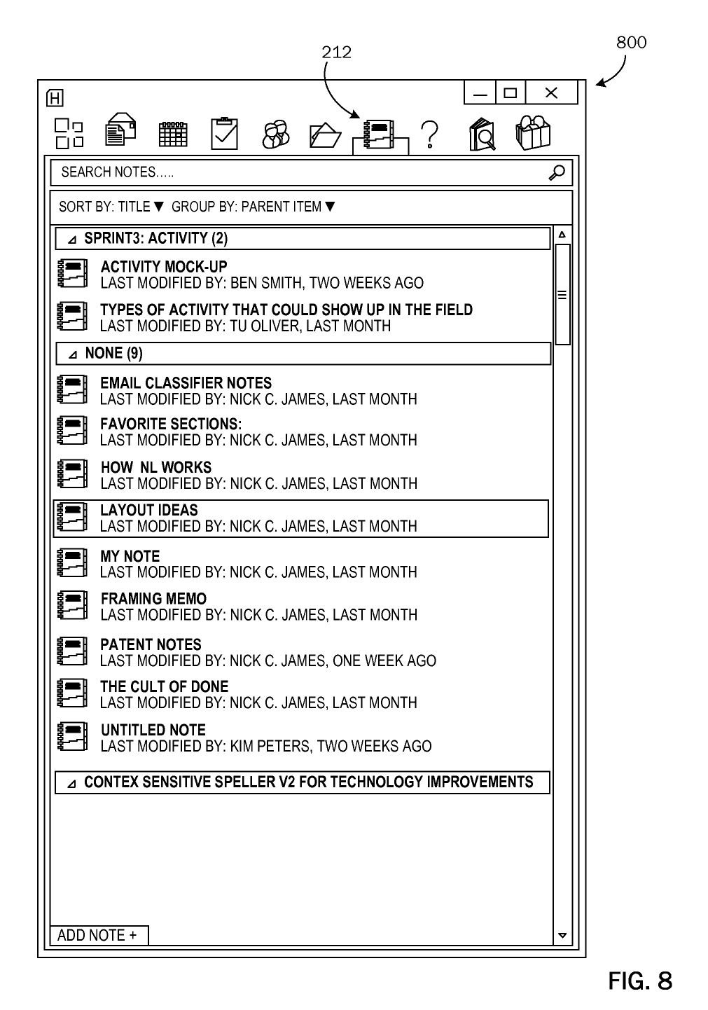

A selection of a notes icon 212 may launch a notes panel 800 as shown in FIG. 8. A notes panel 800 may show all project specific notes associated with any of the other content types in the PDAM application 114. For example, users may add notes to documents, emails, tasks, and people. Notes may also be stand-alone, wherein a note may not be related to another item in a project.

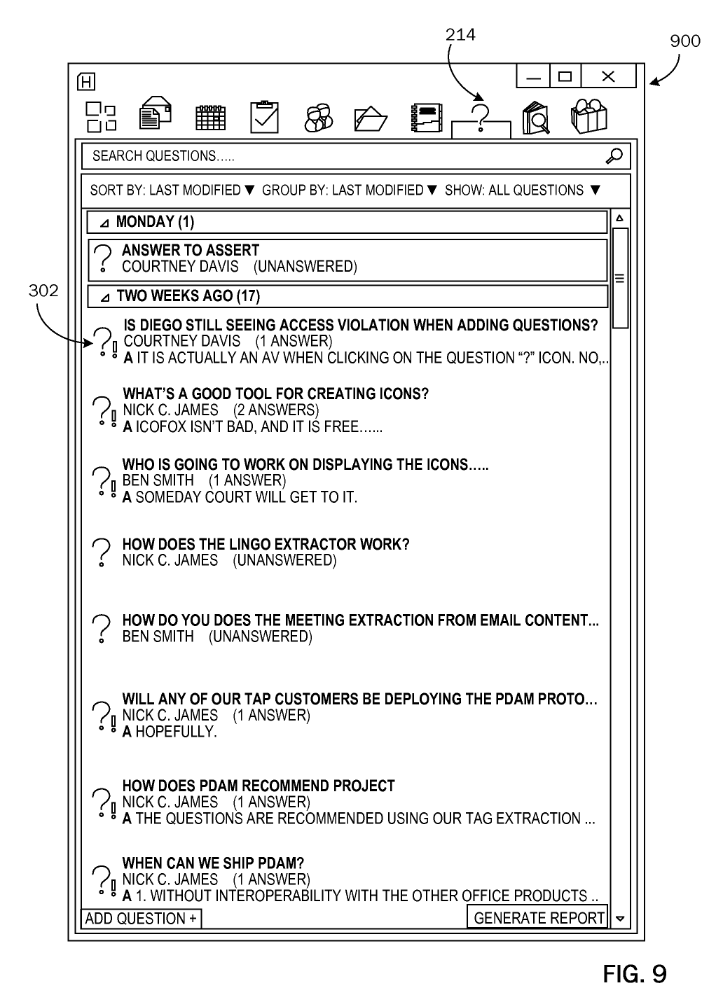

A selection of a question icon 214 may launch a question and answer (hereafter QnA) panel 900 as shown in FIG. 9. A QnA panel 900 is a shared project-specific repository of frequently asked questions. Users may post questions and answers into the panel directly, or by approving QnA items that have been automatically extracted from email (refer to FIG. 3). All items in a QnA panel 900, as well as all content types, may be public, and may be exposed to the rest of an organization via an enterprise-level search.

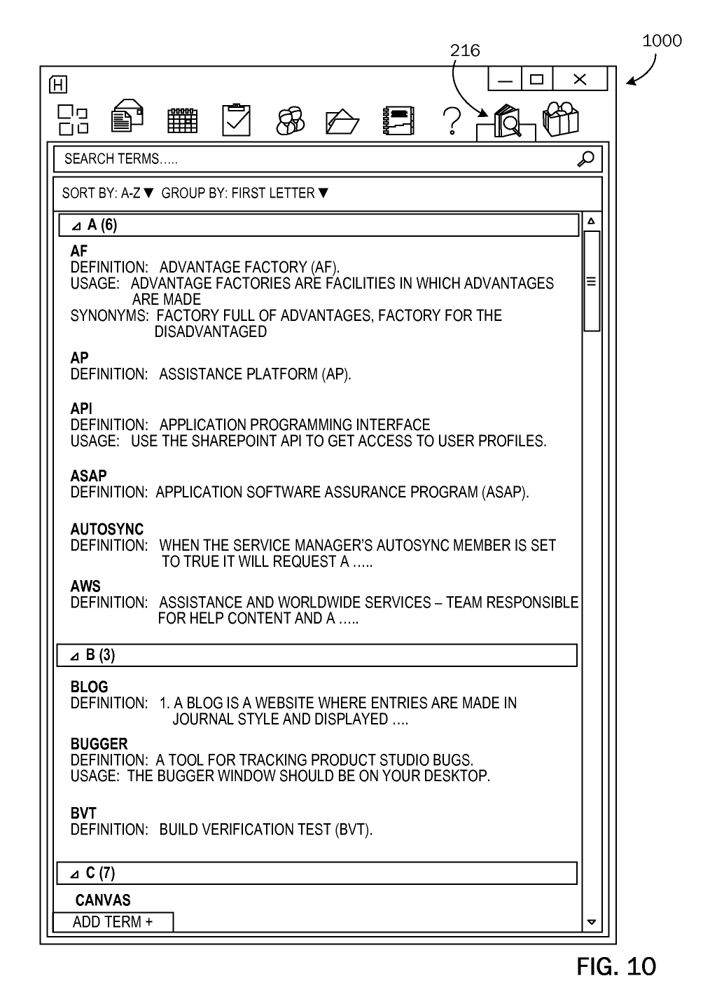

A selection of a lingo icon 216 may launch a lingo panel 1000 as shown in FIG. 10. A lingo panel 1000 is a shared project-specific glossary of terms. Like QnA items of FIG. 9, users may add glossary items manually, or by approving glossary items that have been automatically extracted from documents and emails. According to an embodiment, a glossary item may come from an external source, and may not be extracted from project content.

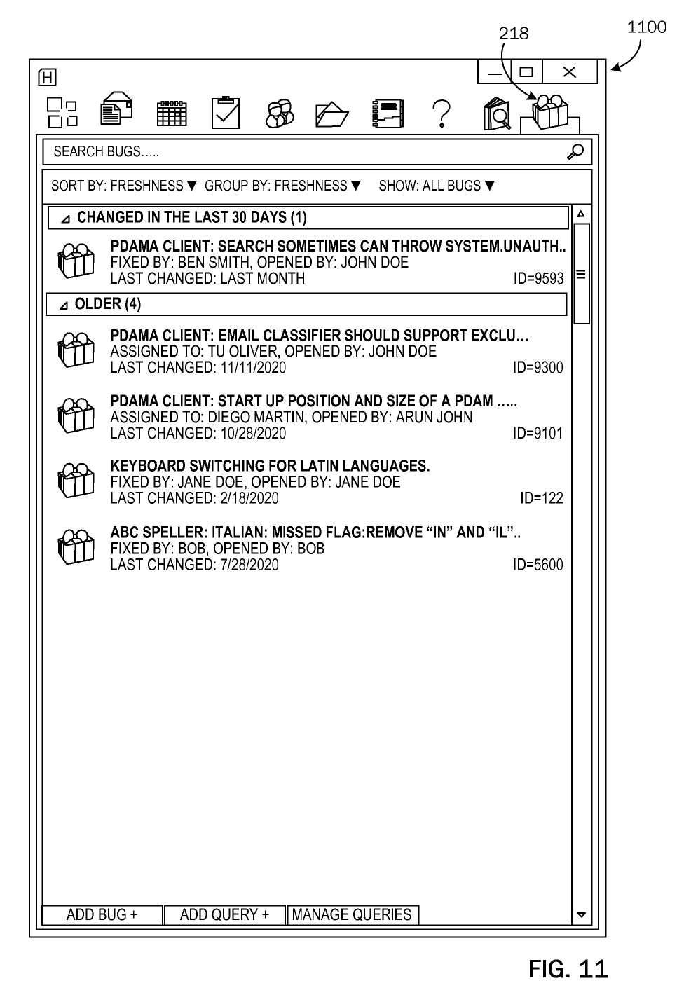

A selection of a bug icon 218 may launch a bug panel 1100 as shown in FIG. 11. The PDAM application 114 may have the ability to federate events and data from certain line of business vertical applications. The panel 1100 shown in FIG. 11 demonstrates integration of the PDAM application 114 with an application which may be utilized to log and track software defects or “bugs,” for example, PRODUCT STUDIO by MICROSOFT CORPORATION.

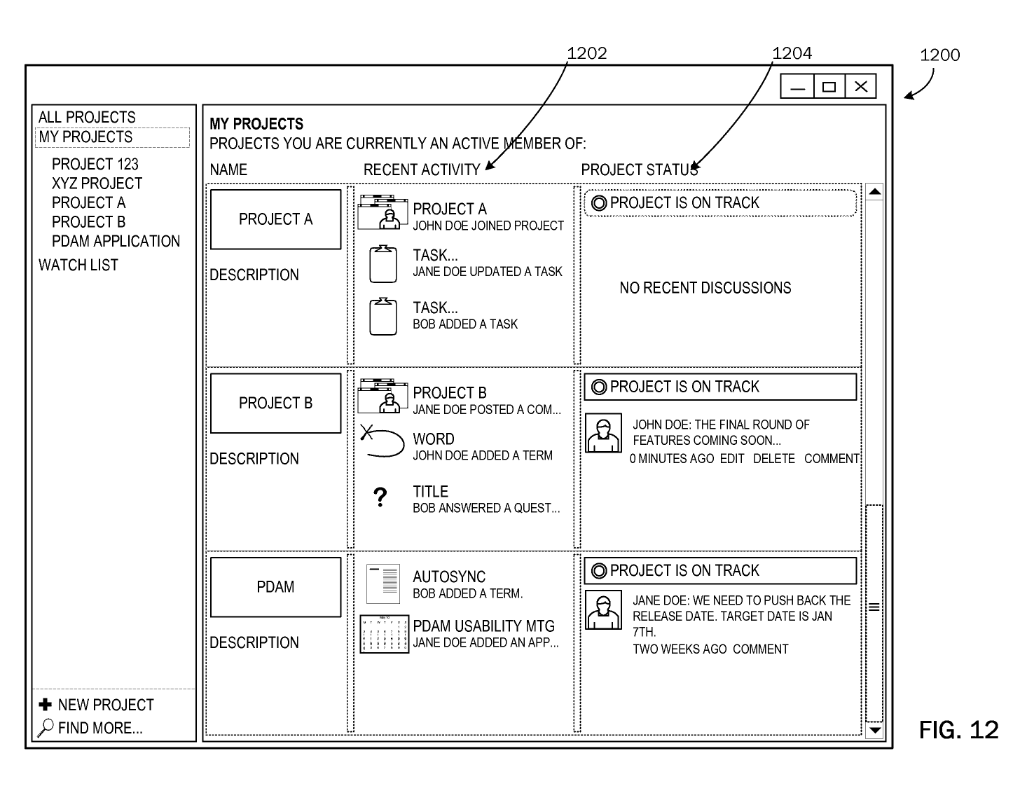

A PDAM application 114 may provide a dashboard panel 1200 as shown in FIG. 12, which may provide users with information from across all their projects in one place. The dashboard panel 1200 may provide an overview of recent activity 1202, status 1204 as well as project highlights or summary information from across all of a user's active projects. Users may search for and enroll in new projects and also create new projects from scratch within the project dashboard 1200.

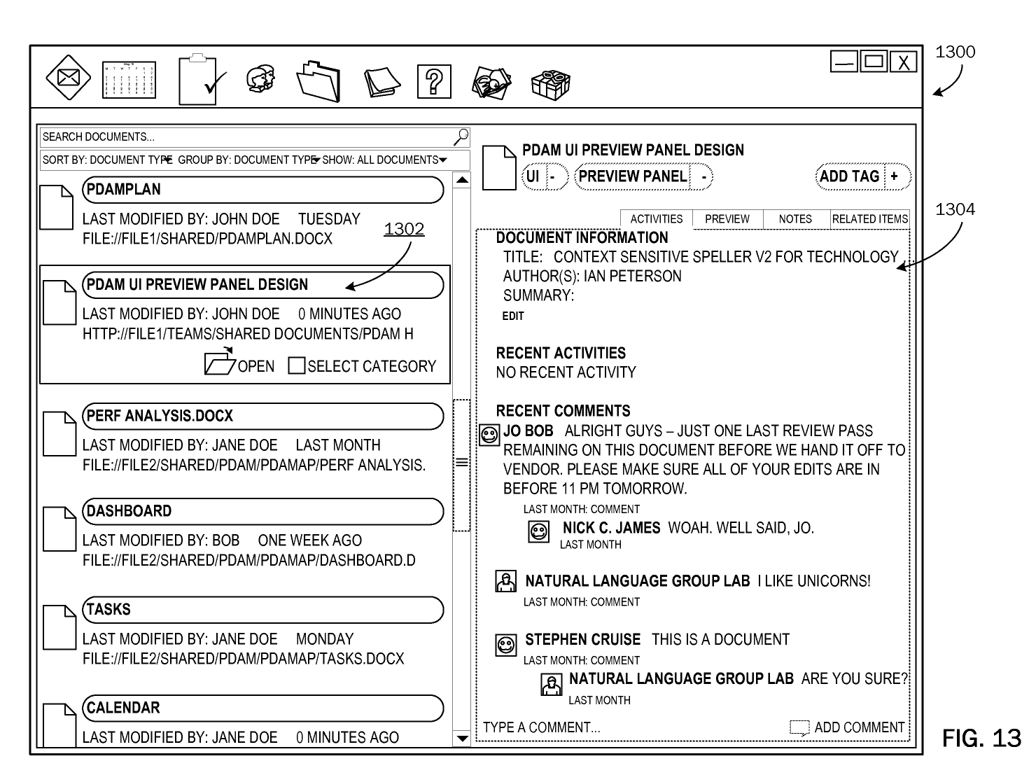

A PDAM application 114 may provide a preview panel 1300 as shown in FIG. 13, which may allow users to view items within the PDAM application without having to launch another application. In addition, the preview panel 1300 may show people-related metadata 110 about an item 1302, including activity information as well as other related items within the project and beyond. An activities page 1304 in the preview panel 1300 may show activity information from members of a project related to the item being viewed 1302. An activities page 1304 may also show interesting metadata 110 related to the item 1302 as well as meta-tags extracted from within the item 1302.

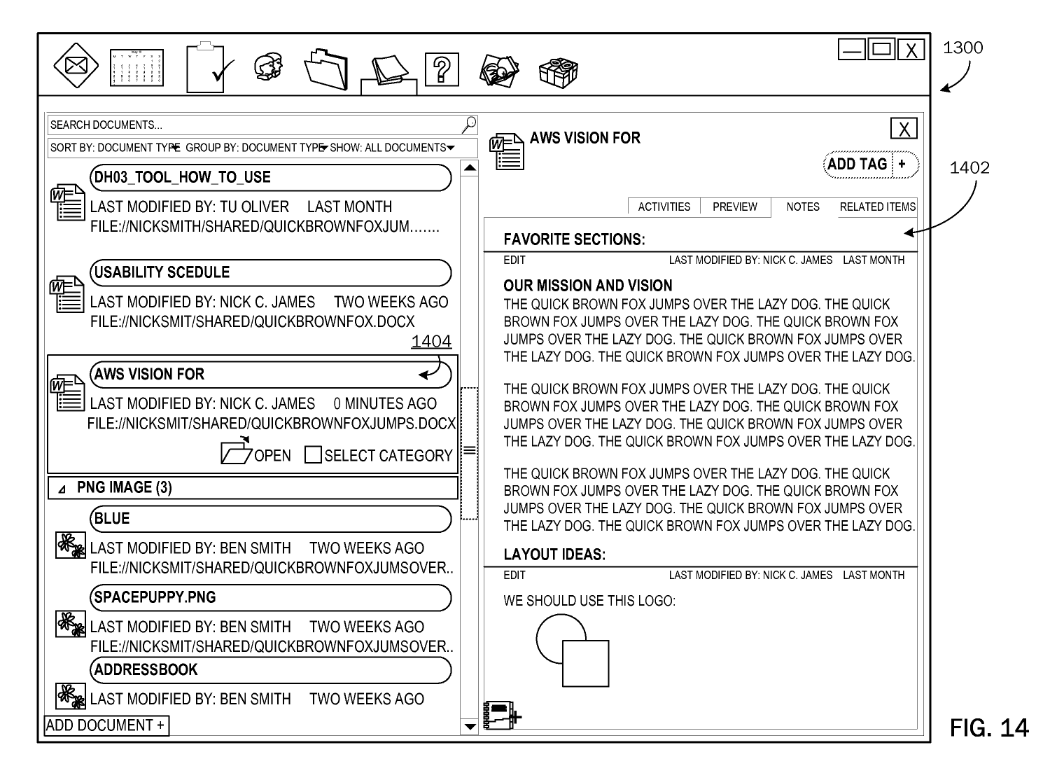

As shown in FIG. 14, a notes page 1402 in a preview panel 1300 may show all of the notes or comments that users have added to a selected item 1404. The notes and comments may be show in a rich manner with formatting and other display attributes found in the notes and/or comments form the data source from which they were retrieved.

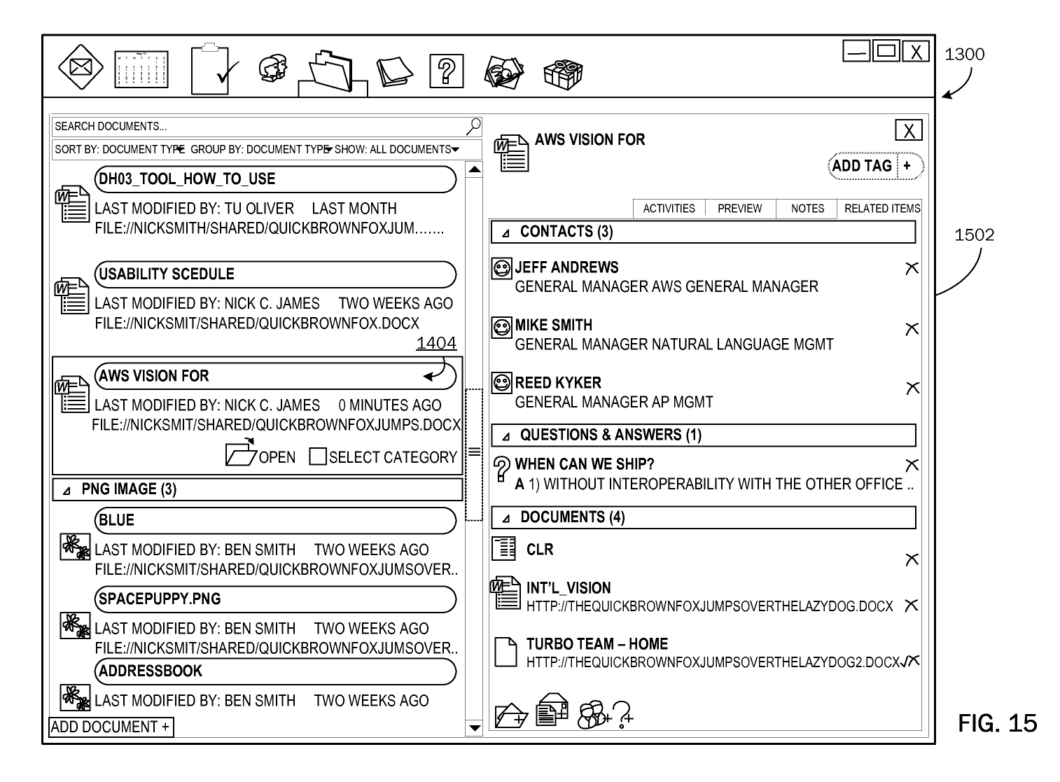

As shown in FIG. 15, a related items page 1502 in a preview panel 1300 may show other items in a project that are related to a selected item 1404. Other items may include, but are not limited to, related documents, emails, people, QnA items, and terms.

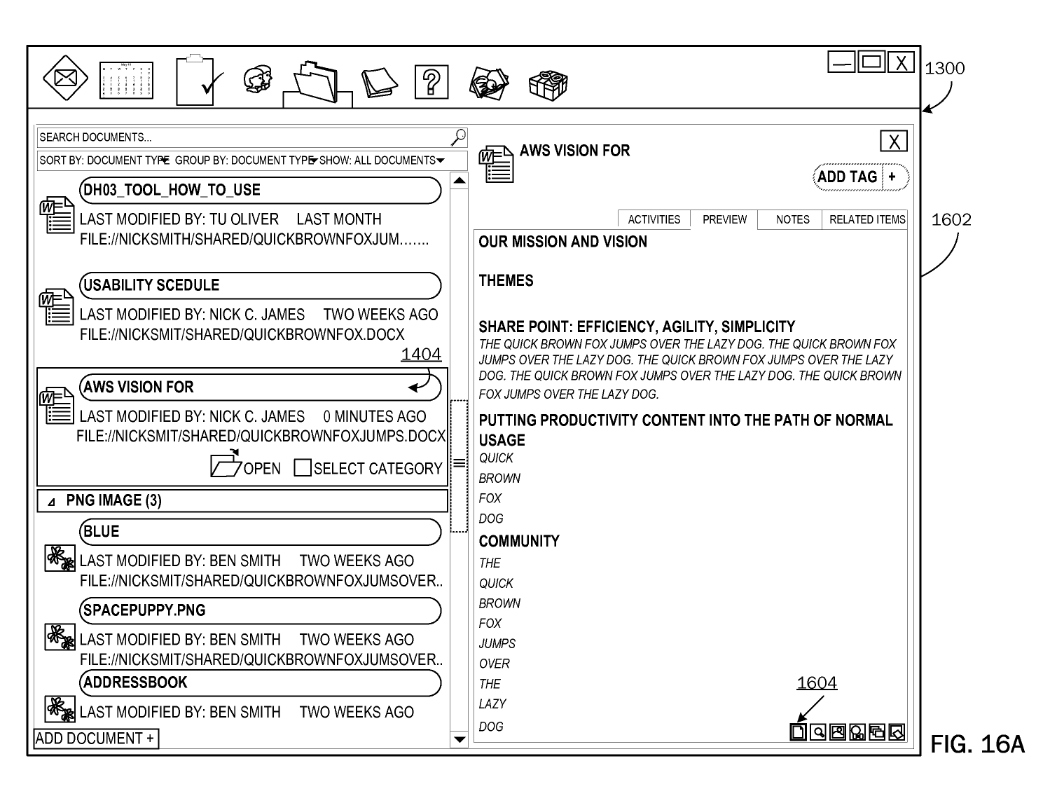

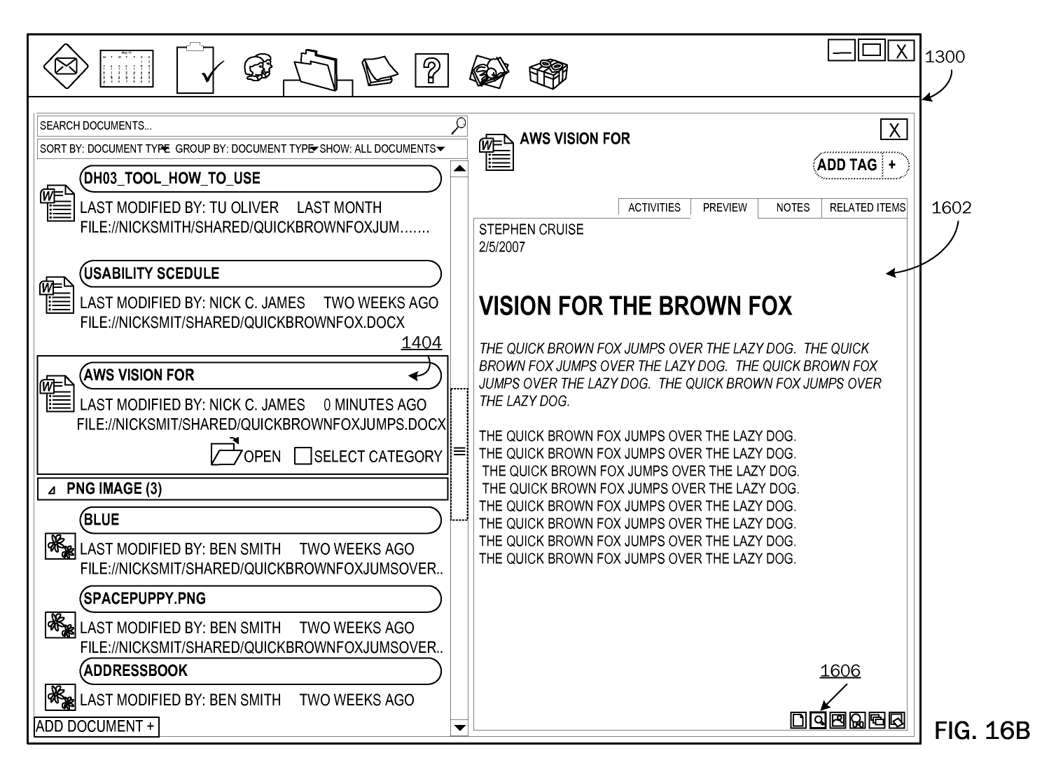

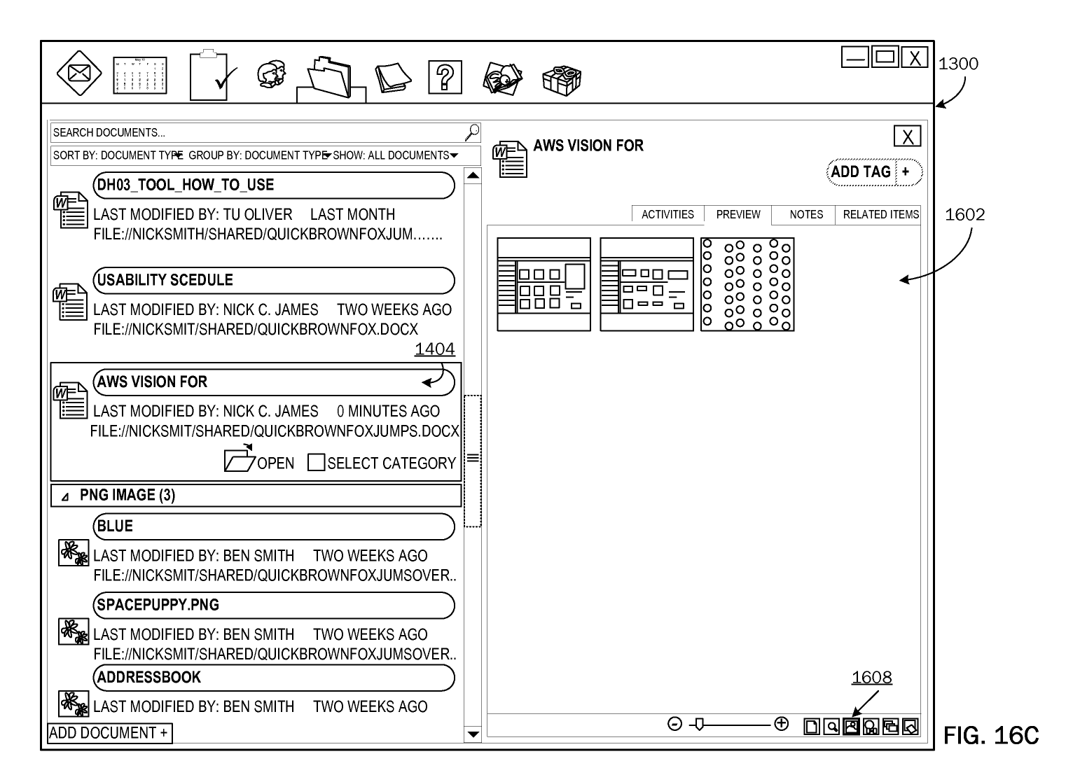

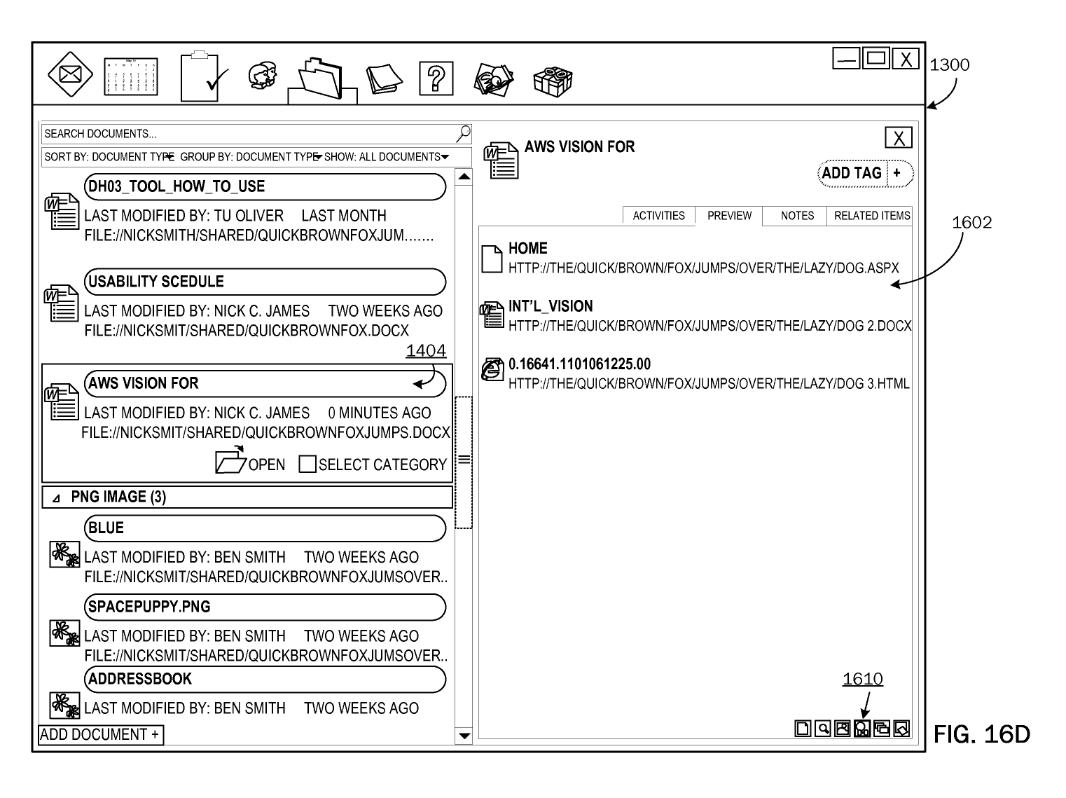

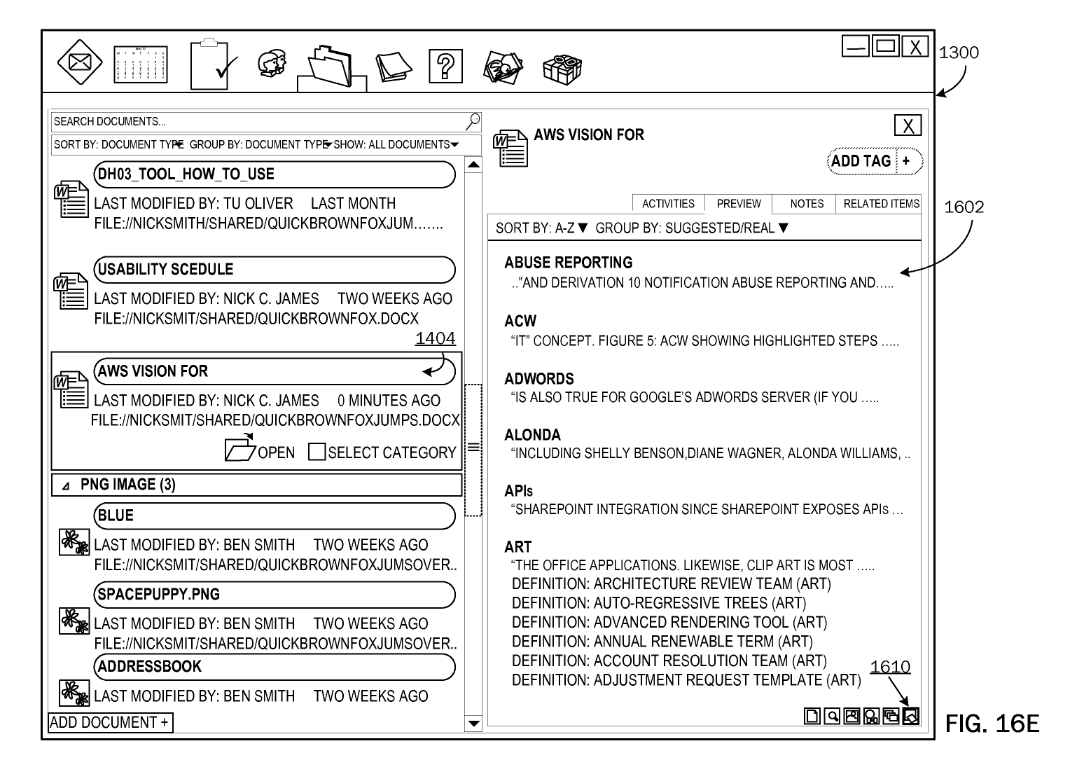

As shown in FIG. 16A, a preview page 1602 in a preview panel 1300 may provide users with a series of “views” on a selected item 1404. A summary tab 1604 may give users a quick summary of the contents of the selected item 1404.

As shown in FIG. 16B, a document preview tab 1606 within a preview panel 1300 may show a full fidelity preview of a selected item 1404.

As shown in FIG. 16C, a clip art preview tab 1608 within a preview panel 1300 may show all the clip art within a selected item 1404. This may help to facilitate quick reuse.

As shown in FIG. 16D, a links tab 1610 within a preview panel 1300 may show all of the links from within a selected item 1404. This may help to facilitate quick click-through and reuse.

As shown in FIG. 16E, a terminology tab 1612 within a preview panel 1300 may show technical terms and acronyms extracted from within a selected item 1404 as well as suggested definitions. Definition suggestions, if present, may be scraped from within the item, or generated via a file repository search.

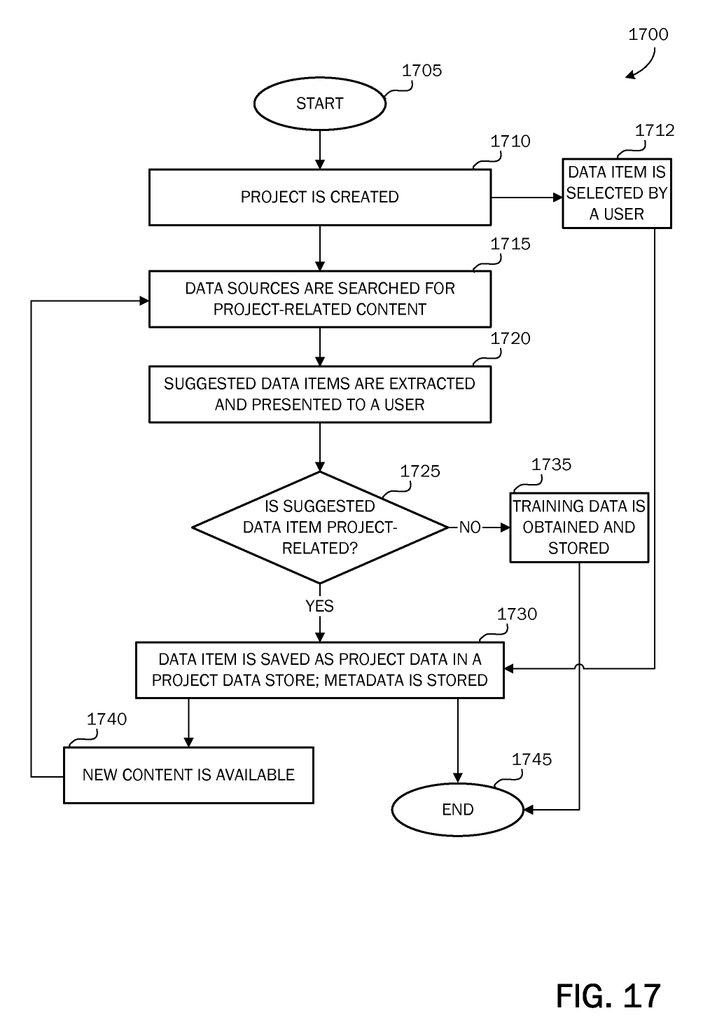

Having described a system architecture and associated user interface views for allowing a user to organize and understand content, discover relevant information, and act on the content and information without regard to where the content and/or information resides or how it was created with respect to FIGS. 1-16 above, FIG. 17 is a flowchart illustrating a method for bringing together project-related content from various data repositories. The method starts at OPERATION 1705 and proceeds to OPERATION 1710, where a project is created within a PDAM application 114. As was described above, a project may be created by a user within a PDAM application 114. When a project is created, the PDAM application receives a project designation, and the project designation is associated with one or more metadata items applied to the project designation, such as a title and description. The metadata items 110 may be used for discovering content that may be of relevance to the project.

The method proceeds to OPERATION 1715, where one or more data sources are identified for obtaining data items, and the data sources 102 are parsed or searched for project-related content. That is, the data sources are parsed for data items relevant to the one or more data items within a project and/or one or more metadata items associated with the project designation. Alternatively, a data item 103 may not be related to existing project data or metadata, but may be parsed according to a specified data collector 104. For example, a data collector 104 may be written for obtaining an arbitrary data item 103, such as a document containing a day's weather report. Data sources may be local or remote. A data collector interface 104 may communicate with a data source 102, and pull or extract data items 103 that may contain relevant information to a project from the data source 102. Embodiments of the present invention may utilize terms entered in the description of the project and utilize them as key phrases for looking for related data.

At OPERATION 1720, data items 103 may be extracted from various data sources 102 and suggested to a user as project-related content. Data items 103 may include, but are not limited to, activities, documents, emails, questions and answers, tasks, calendars, and contacts.

At DECISION OPERATION 1725, a user may accept or decline a suggested data item 103. If a user thinks that a suggested data item 103 is not related to a specified project, the user may decline the suggestion, and the method 1700 proceeds to OPERATION 1735. At OPERATION 1735, training data may be obtained and stored. A PDAM application 114 may utilize training data to recompute data sets used for future classifications and extractions.

If a user believes that a suggested data item 103 is related to a specified project at DECISION OPERATION 1725, the user may accept the suggestion, and the method 1700 proceeds to OPERATION 1730. At OPERATION 1730, the accepted data item 103 is stored within a project data store 108. As described above, the project data store 108 is a data repository or organizational knowledge base, and may be available to and accessed by others. Data collectors 104 may put data into a project data store 108 in whatever way that may be most efficient for the system. Project data 108 may be a collection of identifications to actual data that may be stored locally or in disparate locations. Data may comprise project related content as well as contact information and any other available content that may be relevant to a project. A project data store 108 may also comprise metadata 110, such as a title, description, other people who may be joined and working on a project, security descriptors, types of content that should be stored within a project, and how it should be displayed in a user interface 112. After storage of data items in the project data store, the PDAM UI and the associated views described above with reference to FIGS. 2-16 may be populated for review by a user. According to an embodiment, an overview, illustrated in FIG. 2, of one or more types of data items that are stored for review in association with the project designation may be displayed in a project user interface. In addition, upon receiving a selection of a given type of data item, e.g., 202, 204, stored for review in association with the project designation, one or more data items of the given type of data item for review in association with the project designation, e.g., views 300, 400.

As new content becomes available at OPERATION 1740, a notification may be sent to a data collector 104, wherein the method proceeds to OPERATION 1715 to search for project-related content, and OPERATIONS 1720-1730 may be repeated. Alternatively, OPERATIONS 1720-1730 may be repeated on specified time intervals, e.g., every 30 seconds.

According to another embodiment, project content may be manually input by a user. Once a project is created at OPERATION 1705, at OPERATION 1712, a data item 103 may be determined as project-related and selected by a user. The method proceeds to OPERATION 1730, as was described above. The method ends at OPERATION 1745.

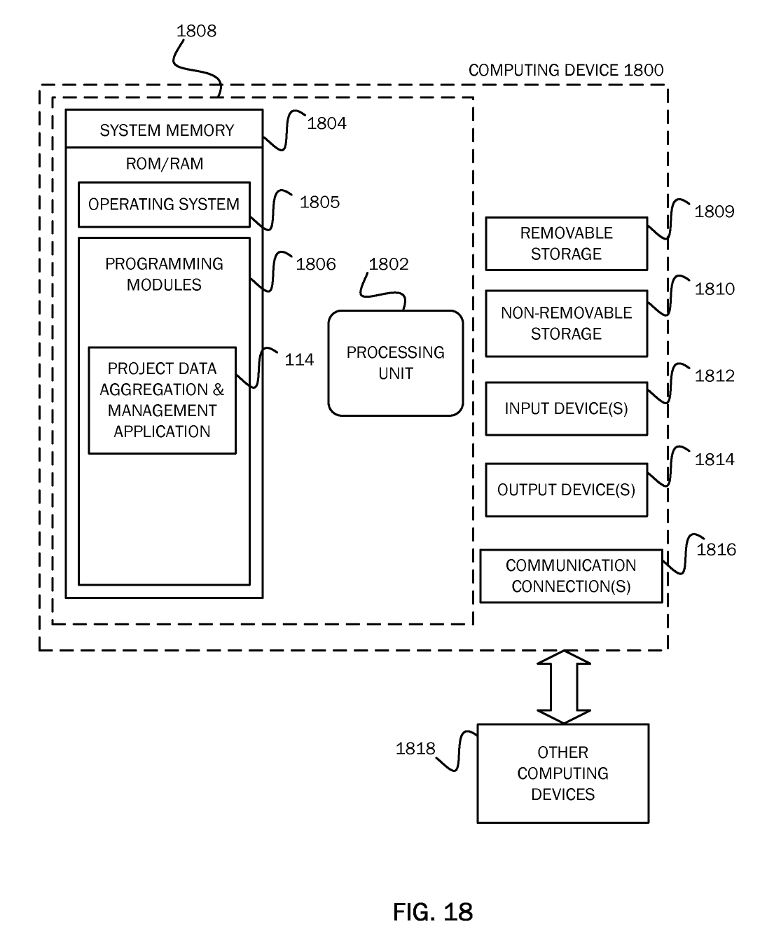

FIG. 18 is a block diagram of a system including computing device 1800. Consistent with an embodiment of the invention, the aforementioned memory storage and processing unit may be implemented in a computing device, such as computing device 1800 of FIG. 18. Any suitable combination of hardware, software, or firmware may be used to implement the memory storage and processing unit. For example, the memory storage and processing unit may be implemented with computing device 1800 or any of other computing devices 1818, in combination with computing device 1800. The aforementioned system, device, and processors are examples and other systems, devices, and processors may comprise the aforementioned memory storage and processing unit, consistent with embodiments of the invention. Furthermore, computing device 1800 may comprise an operating environment for system 100 as described above. System 100 may operate in other environments and is not limited to computing device 1800.

With reference to FIG. 18, a system consistent with an embodiment of the invention may include a computing device, such as computing device 1800. In a basic configuration, computing device 1800 may include at least one processing unit 1802 and a system memory 1804. Depending on the configuration and type of computing device, system memory 1804 may comprise, but is not limited to, volatile (e.g. random access memory (RAM)), non-volatile (e.g. read-only memory (ROM)), flash memory, or any combination. System memory 1804 may include operating system 1805, one or more programming modules 1806, and may include a PDAM application 114. Operating system 1805, for example, may be suitable for controlling computing device 1800's operation. Furthermore, embodiments of the invention may be practiced in conjunction with a graphics library, other operating systems, or any other application program and is not limited to any particular application or system. This basic configuration is illustrated in FIG. 18 by those components within a dashed line 1808.

Computing device 1800 may have additional features or functionality. For example, computing device 1800 may also include additional data storage devices (removable and/or non-removable) such as, for example, magnetic disks, optical disks, or tape. Such additional storage is illustrated in FIG. 18 by a removable storage 1809 and a non-removable storage 1810. Computing device 1800 may also contain a communication connection 1816 that may allow device 1800 to communicate with other computing devices 1818, such as over a network in a distributed computing environment, for example, an intranet or the Internet. Communication connection 1816 is one example of communication media.

As described above, a number of program modules and data files may be stored in system memory 1804, including operating system 1805. While executing on processing unit 1802, programming modules 1806 (e.g. PDMA application 114) may perform processes including, for example, one or more of method 1700's stages as described above. The aforementioned process is an example, and processing unit 1802 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The term computer readable media as used herein may include computer storage media. Computer storage media may include volatile and nonvolatile, removable and non-removable media implemented in any method or technology for storage of information, such as computer readable instructions, data structures, program modules, or other data. System memory 1804, removable storage 1809, and non-removable storage 1810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1800. Any such computer storage media may be part of device 1800. Computing device 1800 may also have input device(s) 1812 such as a keyboard, a mouse, a pen, a sound input device, a touch input device, etc. Output device(s) 1814 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

We claim:

1. A method for aggregating, storing and providing project-related data items, comprising:
receiving a project designation, the project designation associated with one or more metadata items applied to the project designation;
identifying one or more data sources for obtaining data items;
parsing the one or more data sources for data items relevant to the one or more metadata items associated with the project designation;
extracting from the one or more data sources any data items relevant to the one or more metadata items associated with the project designation; and
storing the extracted data items for review in association with the project designation.

2. The method of claim 1, further comprising displaying in a project user interface an overview of one or more types of data items that are stored for review in association with the project designation.

3. The method of claim 2, further comprising
receiving a selection of a given type of data item stored for review in association with the project designation; and
displaying in the project user interface one or more data items of the given type of data item for review in association with the project designation.

4. The method of claim 2, further comprising displaying in a project user interface an overview of project information that may be accessed from one or more project data stores for a plurality of associated project designations.

5. The method of claim 1, wherein parsing the one or more data sources for data items relevant to the one or more metadata items associated with the project designation includes parsing each of the one or more data sources with a data collector associated with each of the specified data types.

6. The method of claim 5, further comprising customizing each data collector associated with each of the specified data types to interface with each associated specified data type to extract data items of the specified data types that are relevant to the one or more metadata items associated with the project designation.

7. The method of claim 6, further comprising associating a plurality of data collectors with a single data source where the single data source includes multiple data types.

8. The method of claim 1, wherein parsing the one or more data sources for data items relevant to the one or more metadata items associated with the project designation includes parsing the one or more data sources at specified time intervals.

9. The method of claim 1, wherein parsing the one or more data sources for data items relevant to the one or more metadata items associated with the project designation includes parsing the one or more data sources upon receiving a notification that one or more data items in the one or more data sources has changed.

10. The method of claim 1, wherein parsing the one or more data sources for data items relevant to the one or more metadata items associated with the project designation includes parsing the one or more data sources via a local storage medium.

11. The method of claim 1, wherein parsing the one or more data sources for data items relevant to the one or more metadata items associated with the project designation includes parsing the one or more data sources via a remote storage medium.

12. The method of claim 1, prior to extracting from the one or more data sources any data items relevant to the one or more metadata items associated with the project designation, suggesting the any data items as being relevant to the one or more metadata items.

13. The method of claim 12, wherein if the any data items are accepted as being relevant to the one or more metadata items associated with the project designation, then storing the extracted data items for review in association with the project designation.

14. The method of claim 1, storing the extracted data items for review in association with the project designation includes storing the extracted data items in a central data repository that may be accessed by a plurality of users associated with the project designation.

15. A system for aggregating, storing and providing project-related data items, comprising:
a project data aggregation and management application operative
to receive a project designation, the project designation including one or more metadata items associated with the project designation;
to receive an identification of one or more data sources for obtaining data items;
a synchronization framework operative
to parse the one or more data sources for data items relevant to the one or more metadata items associated with the project designation;
to extract from the one or more data sources any data items relevant to the one or more metadata items associated with the project designation; and
to store the extracted data items for review in association with the project designation;
the project data aggregation and management application being further operative to display in a project user interface an overview of one or more types of data items that are stored for review in association with the project designation.

16. The system of claim 15, the project data aggregation and management application being further operative
to receive a selection of a given type of data item stored for review in association with the project designation; and
to display in the project user interface one or more data items of the given type of data item for review in association with the project designation.

17. A computer readable medium containing computer-executable instructions which when executed by a computer perform a method for aggregating, storing and providing project-related data items, comprising:
receiving a project designation, the project designation associated with one or more metadata items applied to the project designation;
identifying one or more data sources for obtaining data items of specified data types;
parsing each of the one or more data sources with a data collector associated with each of one or more specified data types;
extracting from the one or more data sources any data items of the one or more specified data types that are relevant to the one or more metadata items applied to the project designation;
storing the extracted data items for review in association with the project designation; and
displaying in a project user interface an overview of one or more types of data items that are stored for review in association with the project designation.

18. The computer readable medium of claim 17, the method further comprising:
receiving a selection of a given type of data item stored for review in association with the project designation; and
displaying in the project user interface one or more data items of the given type of data item for review in association with the project designation.

19. The computer readable medium of claim 17, the method further comprising:
prior to extracting from the one or more data sources any data items of the one or more specified data types that are relevant to the one or more metadata items associated with the project designation, suggesting the any data items as being relevant to the one or more metadata items; and
if the any data items are accepted as being relevant to the one or more metadata items associated with the project designation, then storing the extracted data items for review in association with the project designation.

20. The computer readable medium of claim 19, further comprising:
obtaining and storing training data; and
utilizing the obtained and stored training data to recompute data sets for future classifications and extractions.
